(19) United States
(12) Patent Application Publication
(10) Pub. No.: US 2022/0314252 A1
(43) Pub. Date: Oct. 6, 2022

(54) TRIGGER SPRAYER ASSEMBLY WITH DUAL VALVE SYSTEM

(71) Applicants: Market Ready, Inc., Round Lake Park, IL (US); Cupcake LLC, New York, NY (US)

(72) Inventors: Brandon Donnelly, New York, NY (US); Kyle Hansen, Hartland, WI (US); Alan Gormley, Blessington (IE); Milan-Bob Patadlas, Talisay City (PH); Michael Sawant, Lake Forest, IL (US)

(73) Assignees: Market Ready, Inc., Round Lake Park, IL (US); Cupcake LLC, New York, NY (US)

(21) Appl. No.: 17/712,494

(22) Filed: Apr. 4, 2022

Related U.S. Application Data
(60) Provisional application No. 63/170,676, filed on Apr. 5, 2021.

(51) Int. Cl. B05B 11/00

(52) U.S. Cl. CPC B05B 11/304; B05B 11/3057

(57) ABSTRACT

A trigger sprayer assembly is provided. The assembly includes an engine having a piston chamber and a fluid passage that extends from an inlet portion to an outlet portion, a piston having a plunger that is disposed within the piston chamber, and a trigger lever that is configured to pivot between a neutral position and an actuated position. The assembly further includes an input valve and an output valve configured to control unidirectional fluid flow through the inlet and outlet portions of the fluid passage. The input valve includes a cylindrical body terminating in a flap portion. Pivotal movement of the trigger lever from the actuated position to the neutral position pulls the plunger out of the piston chamber such that the flap portion of the input valve pivots from a closed position to an opened position and fluid flows through the input valve and into the piston chamber.

### CROSS-REFERENCE TO RELATED PATENT APPLICATION

The application claims the benefit of U.S. Provisional Application Ser. No. 63/170,676, filed Apr. 5, 2021, which is incorporated by reference herein in its entirety.

### FIELD

The present disclosure relates to an improved trigger sprayer for dispensing liquids and more particularly to a trigger sprayer with an improved dual valve system.

### BACKGROUND

Trigger sprayer assemblies provide a convenient way to manually dispense many household products and commercial cleaners in a stream, spray, mist, or foam discharge. In some cases, the trigger sprayer may be configured with multiple internal valves such that discharge from the assembly is prevented until a user pumps the trigger lever of the sprayer several times and sufficient fluid pressure has been built up to produce a flow of sufficient power and velocity. This is generally known as a pre-compression system. Depending on the placement and style of the internal valves, existing trigger sprayers with pre-compression systems can be prone to leakage. An improved trigger sprayer assembly with a pre-compression system that prevents leakage would therefore be useful.

### SUMMARY

The present invention is directed to a trigger sprayer assembly that uses two unidirectional valves and reliably minimizes leaking. The trigger sprayer assembly includes an engine having a piston chamber and a fluid passage that extends from an inlet portion to an outlet portion, a piston having a plunger that is disposed within the piston chamber, and a trigger lever that is coupled to the engine and the piston and configured to pivot between a neutral position and an actuated position. The assembly further includes an input valve and an output valve configured to control unidirectional fluid flow through the inlet portion and the outlet portion of the fluid passage. The preferred input valve includes a cylindrical body terminating in a flap portion. Pivotal movement of the trigger lever from the neutral position to the actuated position pushes the plunger into the piston chamber to drive fluid out of the piston chamber and through the output valve, and pivotal movement of the trigger lever from the actuated position to the neutral position pulls the plunger out of the piston chamber such that the flap portion of the input valve pivots from a closed position to an opened position and fluid flows through the input valve and into the piston chamber.

According to another embodiment of the present invention, the output valve includes a plug portion, a conical seat portion extending from the plug portion, and multiple flexible members radially distributed about and extending from an outer periphery of the conical seat portion. In this embodiment, the assembly includes an engine having a piston chamber and a fluid passage that extends from an inlet portion to an outlet portion, a piston having a plunger that is disposed within the piston chamber, and a trigger lever that is coupled to the engine and the piston and configured to pivot between a neutral position and an actuated position. The assembly further includes an input valve configured to control unidirectional fluid flow through the inlet portion of the fluid passage, and an output valve configured to control unidirectional fluid flow through the outlet portion of the fluid passage. As mentioned, the output valve includes a plug portion, a conical seat portion extending from the plug portion, and multiple flexible members radially distributed about and extending from an outer periphery of the conical seat portion. The flexible members terminate in a ring member. Pivotal movement of the trigger lever from the neutral position to the actuated position pushes the plunger into the piston chamber to drive fluid out of the piston chamber such that the flexible members deform from a closed position to an opened position to permit a flow of fluid through the output valve, and pivotal movement of the trigger lever from the actuated position to the neutral position pulls the plunger out of the piston chamber such that the input valve permits a flow of fluid through the input valve and into the piston chamber.

According to yet another embodiment of the present invention, a unidirectional valve for a trigger sprayer assembly is provided. The unidirectional valve includes a base cylindrical body, and an upper cylindrical body extending from the base cylindrical body and terminating in a flap portion. The flap portion is configured to pivot upwardly from a closed position to an opened position to permit a flow of fluid through the unidirectional valve.

### BRIEF DESCRIPTION OF THE DRAWINGS

The present invention is described with reference to the following Figures. The same numbers are used throughout the Figures to reference like features and like components.

FIG. 1 is a perspective view of a trigger sprayer assembly according to an exemplary embodiment of the present invention.

FIG. 2 is a side view of the trigger sprayer assembly of FIG. 1.

FIG. 3 is an exploded view of the trigger sprayer assembly of FIG. 1.

FIG. 4A is a perspective view of an input valve used in the trigger sprayer assembly of FIG. 1.

FIG. 4B is a side view of the input valve of FIG. 4A.

FIG. 4C is a side cross-sectional view of the input valve taken along the line 4C-4C of FIG. 4A.

FIG. 5A is a perspective view of an output valve used in the trigger sprayer assembly of FIG. 1.

FIG. 5B is a side view of the output valve of FIG. 5A.

FIG. 5C is a side cross-sectional view of the input valve taken along the line 5C-5C of FIG. 5A.

FIG. 6A is a side cross-sectional view of the trigger sprayer assembly of FIG. 1.

FIG. 6B is a side cross-sectional view depicting a flow of fluid through the trigger sprayer assembly of FIG. 1 as a trigger component moves from a neutral position to a depressed position.

FIG. 6C is a side cross-sectional view depicting a flow of fluid through the trigger sprayer assembly of FIG. 1 as the trigger component moves from the depressed position to the neutral position.

FIG. 7 is a perspective view of an engine used in the trigger sprayer assembly of FIG. 1.

FIG. 8 is detail view depicting a flow of fluid into a piston chamber of the trigger sprayer assembly of FIG. 1.

FIG. 9A is a perspective view depicting an input housing used in the trigger sprayer assembly of FIG. 1.

FIG. 9B is a side view of the input housing of FIG. 9A.

FIG. 9C is a side cross-sectional view of the input housing taken along the line 9C-9C of FIG. 9A.

FIG. 10A is a perspective view of another output valve used in the trigger sprayer assembly of FIG. 1.

FIG. 10B is another perspective view of the output valve of FIG. 10A.

FIG. 10C is a side view of the output valve of FIG. 10A.

FIG. 10D is a side cross-sectional view of the output valve taken along the line 10D-10D of FIG. 10A.

FIG. 11A is a side cross-sectional view of another exemplary embodiment of a trigger sprayer assembly.

FIG. 11B is a side cross-sectional view of the trigger sprayer assembly of FIG. 11A depicting a flow of fluid as a trigger component moves from a neutral position to a depressed position.

FIG. 11C is a side cross-sectional view of the trigger sprayer assembly of FIG. 11A depicting a flow of fluid as the trigger component moves from the depressed position to the neutral position.

### DETAILED DESCRIPTION

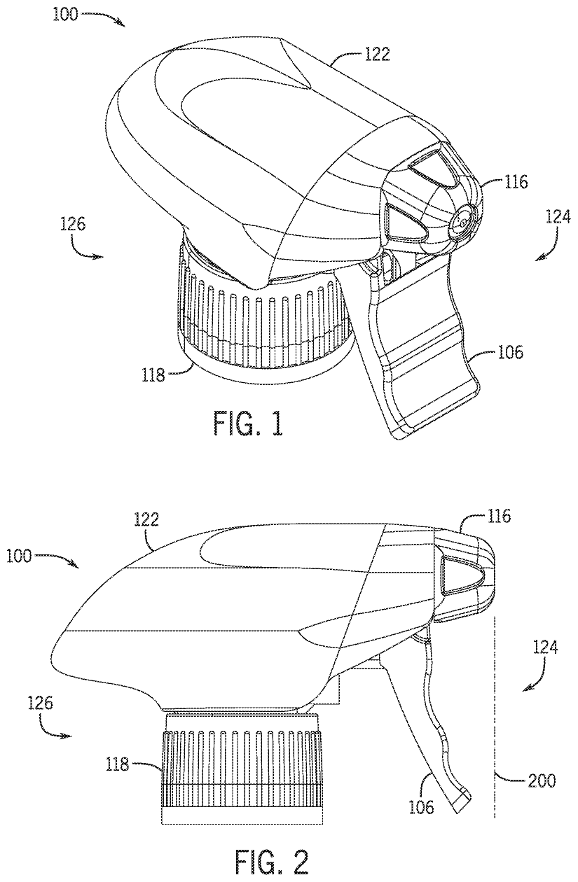

FIGS. 1-3 depict an improved trigger sprayer assembly 100 according to an exemplary embodiment of the present invention. The trigger sprayer assembly 100 may be adapted to dispense a fluid (e.g., cleaning products, industrial products, water, cosmetics, food products) housed within a bottle or container (not shown) in a stream, spray, or mist dispensing pattern. To operate the sprayer assembly 100, a user grips a trigger component 106 at a front end 124 of the assembly 100, positioning a thumb at the joint between a neck closure 118 and a shroud 122 at a rear end 126 of the assembly 100. By depressing or squeezing the trigger component 106 toward the rear end 126 from a relaxed or neutral position to a depressed or actuated position, fluid from the bottle or container is driven out through a nozzle 116. Advantageously, as depicted in FIG. 2, in the neutral position, the trigger lever component 106 resides entirely to the rear of a plane 200 that is coincident with a front face of the nozzle 116. This arrangement ensures that the trigger sprayer assembly 100 is easier to package, ship, and store than a comparable trigger sprayer assembly in which the trigger lever component extends in front of the plane 200. In some embodiments, the nozzle 116 is configured to rotate relative to the shroud 122 to permit a user to close or open a fluid passage that terminates at the nozzle 116, and to select a desired dispensing pattern (e.g., stream, spray, mist).

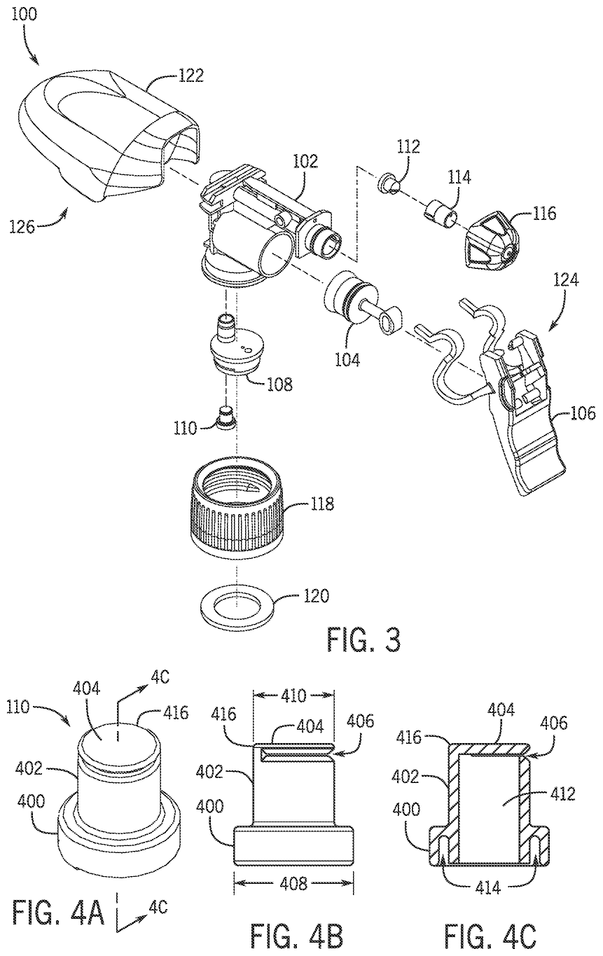

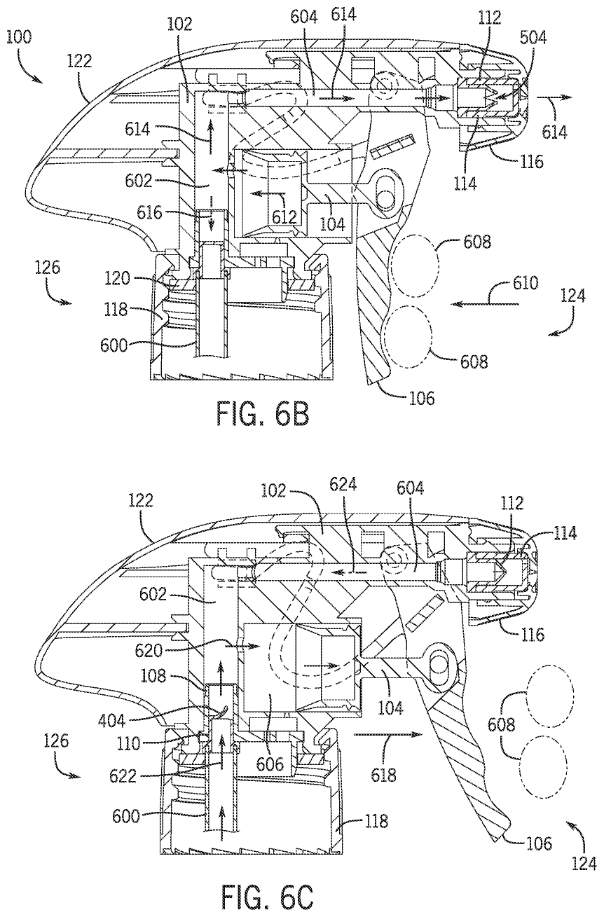

Referring specifically to the exploded view depicted in FIG. 3, the internal components of the trigger sprayer assembly 100 are shown. These internal components include an engine 102 with a piston chamber and a fluid outlet passage (e.g., piston chamber 606, fluid outlet passage 602, 604 described in further detail below with reference to FIG. 6), and a piston component 104 that is coupled to the trigger component 106 and configured to slide within the piston chamber. As the trigger component 106 is depressed toward the rear end 126 of the assembly 100, the piston component 104 is likewise forced by the trigger component 106 toward the rear end 126, which decreases the volume of the piston chamber and forces fluid within the piston chamber into the fluid outlet passage within the engine 102 and out through the nozzle 116, provided that the nozzle 116 is rotated to an opened position. When the actuating force has been removed and the trigger component 106 relaxes toward the front end 124, the trigger component 106 pulls the piston 104 outwardly from the piston chamber, thereby increasing the volume of the piston chamber and drawing a supply of fluid into the piston chamber.

An input housing 108 is shown to be positioned below the engine 102. The input housing 108 may be configured to couple to a dip tube (e.g., dip tube 600, depicted in FIGS. 6A-6C) that extends into the bottle or container of fluid and provides a path for the fluid to be drawn upwards into the sprayer assembly 100. The input housing 108 also provides a seat for a one-way input valve 110 that regulates a flow of fluid into the engine 102. Further details regarding the input valve 110 are included below with reference to FIGS. 4A-4C. As shown in FIGS. 3 and 6A-6C, the input housing 108 is shown to include a generally cylindrical base portion with a larger diameter than a generally cylindrical seat portion that extends upwardly therefrom. As specifically depicted in FIGS. 6A-6C, the input valve 110 is shown to be press fit within the cylindrical seat portion. The seat portion does not extend from a center of the base portion, but is instead offset from the center of the base portion. In this way, the input housing 108 provides both a seat for the input valve 110, and through the presence of vent holes (e.g., vent holes 804, 806, see FIG. 8) that fluidly couple the piston chamber to the fluid container, pressure equalization and drainage for the piston chamber.

As shown in FIG. 3, a neck closure 118 is shown to be positioned below the input housing 108 and the one-way input valve 110. The neck closure 118 is configured to be utilized to couple the engine 102 to any desired bottle or container (not shown). As such, the dimensions of the neck closure (e.g., height, outer diameter, inner diameter) may be variable based on the size and shape of the bottle or container housing the liquid to be dispensed. In an exemplary implementation, the neck closure 118 includes threads and is configured to be threadably coupled to a neck portion of the bottle or container. In other implementations, the neck closure 118 is coupled to a neck portion of the bottle or container using a snap fit assembly process. A sealing gasket 120, shown positioned below the neck closure 118, may be utilized to ensure that fluid does not seep between the engine 102 and the input housing 108, and out through the neck closure 118, particularly in the case if the trigger sprayer assembly 100 is tilted or inverted.

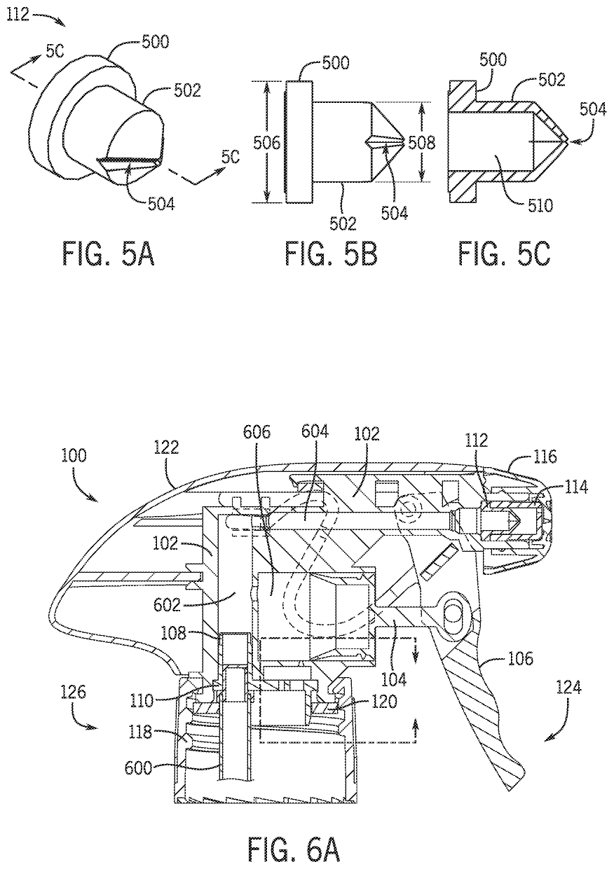

Still referring to FIG. 3, the internal components of the trigger sprayer assembly 100 are also shown to include an output or nozzle valve 112 and a water jacket 114. The nozzle valve 112, like the input valve 110, may be a one-way valve that is configured to only permit the passage of fluid once a fluid pressure threshold is exceeded. Further details regarding the output valve 112 are included below with reference to FIGS. 5A-5C. The water jacket 114 may be configured to fit over the nozzle valve 112 and prevent the leakage of fluid at the joint between the engine 102 and the nozzle component 116, particularly in a case in which the trigger sprayer assembly 100 is tilted or positioned such that the nozzle component 116 faces downwardly.

FIGS. 4A-4C respectively depict isometric, side, and side cross-sectional views of the input valve 110. The input valve 110 is shown to include a generally cylindrically-shaped base portion 400 and a generally cylindrically-shaped upper portion 402 that extends from the base portion 400. In an exemplary embodiment, an outer diameter 408 of the base portion 400 is approximately 6.5 mm, and an outer diameter 410 of the upper portion 402 is approximately 4.4 mm.

A flap portion 404 is shown to be positioned at an upper end of the upper portion 402 opposite the base portion 400. In an exemplary embodiment, a thickness of the flap portion 404 is approximately (i.e., ±10%) 0.55 mm. The flap portion 404 is movable relative to the upper portion 402 due to the presence of a semi-circular slit 406 that forms a living hinge between the upper portion 402 and the flap portion 404. In an exemplary embodiment, the slit 406 extends approximately 180° around the upper portion 402 and has a height of 0.10 mm. In other embodiments, the slit 406 may extend around a greater or lesser amount of the upper portion 402 (e.g., 120°, 270°). FIGS. 4A-4C depict the flap portion 404 in a closed position. The closed position prevents a free flow of fluid through a central passage 412 (see FIG. 4C). When fluid pressure causes the flap portion 404 to pivot upwardly into an opened position (see FIG. 6C), fluid can freely flow through the central passage 412.

As specifically depicted in FIG. 4C, the base portion 400 is also shown to include an annular groove 414. The annular groove 414 may be configured to receive a dip tube (e.g, dip tube 600, depicted FIG. 6A) to provide a path for fluid to travel upwardly from the fluid container into the engine 102. Accordingly, the dimensions of the annular groove 414 (e.g., height, width), may be any dimensions required to securely retain the dip tube.

Referring now to FIGS. 5A-5C, isometric, side, and side cross-sectional views of the output valve 112 are respectively depicted. The output valve 112 is shown to include a generally cylindrically-shaped base portion 500, and a generally cylindrically-shaped main body portion 502 that terminates in a conical slit portion 504. In an exemplary embodiment, an outer diameter of the base portion 500 is approximately 7.0 mm, and an outer diameter of the main body portion 502 is approximately 4.6 mm.

FIGS. 5A-5C depict the conical slit portion 504 in a closed position that prevents a free flow of fluid through a central passage 510 (see FIG. 5C). However, upon the presence of sufficient fluid pressure within the central passage 510, the conical slit portion 504 is configured to deform relative to the main body portion 502 to permit fluid to freely flow through the central passage 510 (see FIG. 6B).

In an exemplary embodiment, both the input valve 110 and the output valve 112 are fabricated from a thermoplastic elastomer (TPE) using an injection molding process. TPE exhibits many properties advantageous to valves in contact with a variety of fluids, including high abrasion resistance, high fatigue resistance, high elasticity, chemical resilience, and low compression set. In other embodiments, the input valve 110 and the output valve 112 may be fabricated from a different material, for example, liquid silicone rubber, or using a different manufacturing process.

FIGS. 6A-6C depict side cross-sectional views of the trigger sprayer assembly 100 as an actuation cycle occurs. Specifically, FIG. 6A depicts the trigger sprayer assembly 100 in a neutral or relaxed position prior to application of an actuating force, FIG. 6B depicts the trigger sprayer assembly 100 in a depressed or actuated position during application of the actuating force, and FIG. 6C depicts the trigger sprayer assembly 100 returned to the neutral or relaxed position upon removal of the actuating force.

As shown in FIG. 6B, when a user positions their fingers 608 against the trigger lever 106 and applies an actuating force represented by arrow 610 to move the trigger lever 106 from the neutral position to the actuated position, the piston component 104 is driven toward the rear end 126 of the assembly 100, thereby decreasing the volume within the piston chamber 606 (see FIG. 6A). The decrease in volume causes fluid flow represented by arrow 612 to exit the piston chamber 606 and enter vertical portion 602 of the fluid outlet passage. When the trigger lever 106 is subsequently actuated after several initial actuations that prime the trigger sprayer assembly 100 to dispense fluid, nearly all of the fluid exiting into the vertical portion 602 is fluid that was previously drawn upwardly through the dip tube 600 and input housing 108 into the piston chamber 606. Once the fluid has exited the piston chamber 606, a first portion of the fluid flow represented by arrow 614 travels upwardly in the vertical portion 602 and toward the front end 124 of the assembly through horizontal portion 604 of the fluid outlet passage. Pressure from the fluid flow 614 against the nozzle valve 112 located in the nozzle component 116 forces the conical slit portion 504 to deform and the fluid to flow through the nozzle valve 112. If the nozzle component 116 has been rotated to an opened position, the fluid flow 614 exits the trigger sprayer assembly 100 through the water jacket 114 and the nozzle component 116. In an exemplary embodiment, the liquid output per actuation of the trigger lever 106 is at least 1.3 cubic centimeters (CC), and preferably between 1.6 and 1.7 CC. In an exemplary implementation, an actuation force to achieve this liquid output is preferably between 60 and 75 N.

A second portion of the fluid flow represented by the arrow 612 is shown to exit the piston chamber 606 and travel downwardly in the vertical portion 602 toward the input housing 108 and the input valve 110 if this part of the fluid path is not already filled with liquid. The pressure of this fluid filling vertically downwards acts upon the flap portion 404 to maintain the input valve 110 in the closed position, thus preventing the flow of any fluid from traveling upwardly through the dip tube 600 and the input valve 110. Closing the flap portion 404 of the input valve 110 also maintains the pressure in the fluid outlet passages 602, 604 to enable the discharge of fluid through the nozzle 614 if it is in an opened position.

As shown in FIG. 6C, when a user removes their fingers 608 from the trigger lever 106, springs cause the trigger lever 106 to move from the actuated position to the neutral position in the direction represented by the arrow 618. The coupling of the trigger lever 106 and the piston component 104 pulls the piston component 104 outwardly toward the front end 124 of the assembly 100, thereby increasing the volume of the piston chamber 606 and creating a vacuum that draws fluid into the piston chamber 606 as indicated by the arrow 620. A first portion of the fluid flowing in the direction of arrow 622 flows through the dip tube 600 and forces the flap portion 404 to pivot upwardly to an opened position to permit fluid to flow through the input valve 110. In the absence of the motive force provided by the fluid exiting the piston chamber 606, the second portion of the fluid positioned above the piston chamber 600 and represented by arrow 624 does not exert sufficient pressure against the nozzle valve 112 to deform the conical slit portion 504, therefore flow through the nozzle component 116 is arrested.

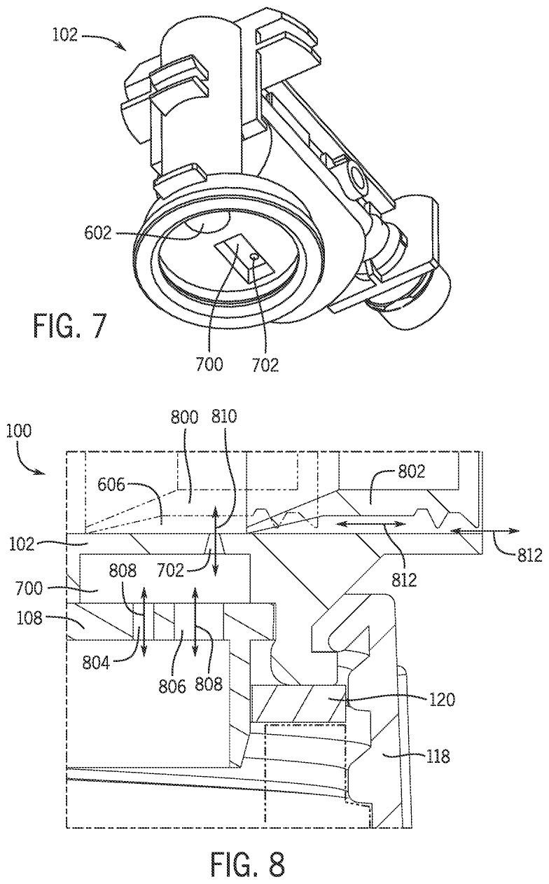

FIGS. 7 and 8 respectively depict a lower perspective view of the engine 102 and a detail view of region below the piston chamber 606. The engine 102 is shown to include an air chamber 700 and vent hole 702 positioned near the vertical portion 602 of the fluid outlet passage and below the piston chamber 606. As the plunger portion of the piston component moves between the actuated position (depicted as plunger 800 in FIG. 8) and the neutral position (depicted as plunger 802 in FIG. 8), vent hole 702, as well as vent holes 804 and 806 formed in the input housing 108 permit the free flow of air and/or fluid as indicated by the arrows 808. In this way, the plunger of the piston component can freely move within the piston chamber 606 between positions 800 and 802, and adequate pressure levels within the piston chamber 606 can be maintained to control the flow of fluid into and out of the piston chamber 606. In addition, when a user is finished dispensing fluid and has removed the actuating force, any fluid remaining within the piston chamber 606 can freely drain back into the fluid container.

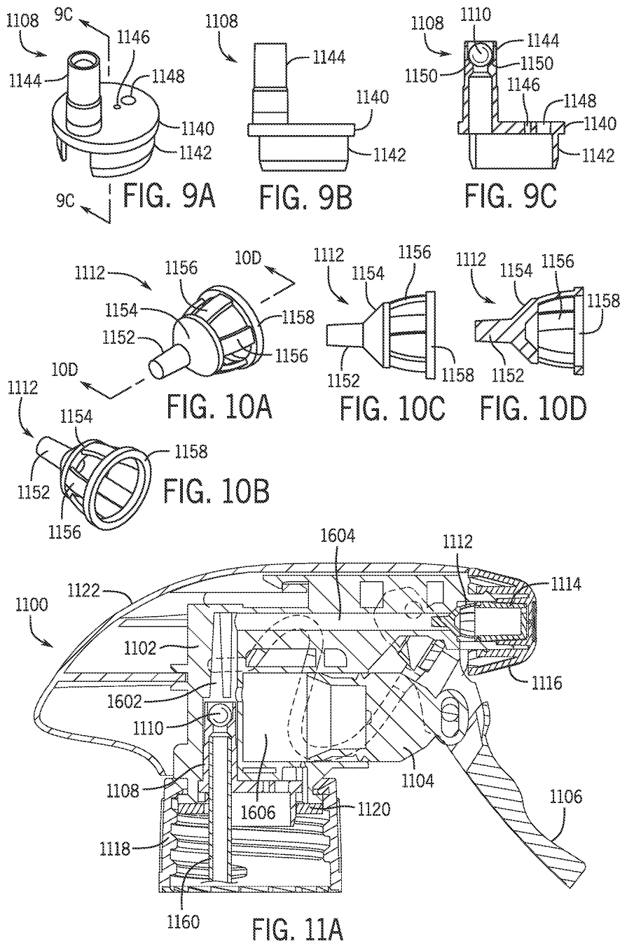

Turning now to FIGS. 9A-9C, an alternative embodiment of the input housing 1108 and input valve 1110 are depicted. Input housing 1108 and input valve 1110 may be used in place of the input housing 108 and input valve 110 as depicted and described above with reference to FIGS. 3-6C. The input housing 1108 is shown to include a generally disc-shaped base portion 1140 with a lower flange 1142 and an upper cylindrical portion 1144 extending in opposite directions therefrom. The base portion 1140 further includes vent holes 1146 and 1148, the purpose of which is identical or substantially similar to vent holes 804 and 806, described above with reference to FIG. 8.

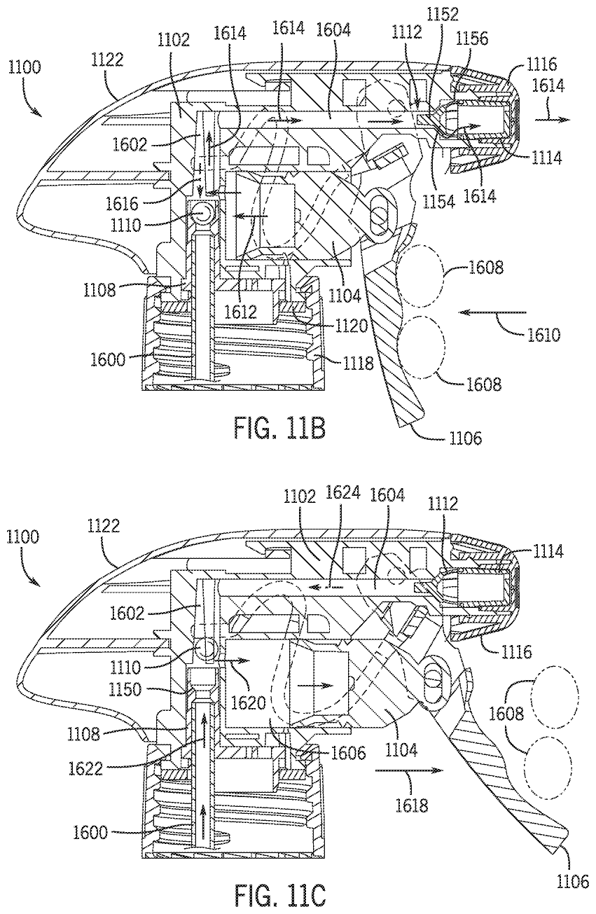

As specifically depicted in FIG. 9C, the upper cylindrical portion 1144 includes a conical region 1150 that functions as a valve seat for a ball member 1110. Further description regarding the operation of the ball member 1110 and the valve seat is included below with reference to FIGS. 11A-11C. In various embodiments, the ball member 1110 may be fabricated from TPE, ceramic, glass, or metal (e.g., a 304 or 316 grade stainless steel).

Referring now to FIGS. 10A-10D, an alternative embodiment of the output or nozzle valve 1112 is depicted. The output valve 1112 may be used in place of the output valve 112, depicted and described above with reference to FIGS. 3-6C. Output valve 1112 is shown to include a solid plug portion 1152 and a conical seat portion 1154. Multiple flexible members 1156 are radially distributed about an outer periphery of the conical seat portion 1154 and terminate in a ring-shaped member 1158. Further details regarding the operation of the output valve are included below with reference to FIGS. 11A-11C. In an exemplary embodiment, output valve 1112 is fabricated from TPE using an injection molding process, similar to the input valve 110 and output valve 1112 described above with reference to FIGS. 4A-5C.

FIGS. 11A-11C depict side cross-sectional views of an alternative embodiment trigger sprayer assembly 1100 as an actuation cycle is completed. Specifically, FIG. 11A depicts the trigger sprayer assembly 1100 in a neutral or relaxed position prior to application of an actuating force, FIG. 11B depicts the trigger sprayer assembly 1100 in a depressed or actuated position during application of the actuating force, and FIG. 11C depicts the trigger sprayer assembly 1100 returned to the neutral or relaxed position upon removal of the actuating force. The trigger sprayer assembly 1100 is shown to include multiple components (e.g., engine 1102, piston component 1104, trigger lever 1106, water jacket 1114, nozzle component 1116, neck closure 1118, sealing gasket 1120, shroud 1122) that are either identical or substantially similar to the components described above with reference to FIGS. 6A-6B.

As shown in FIG. 11B, as a user positions their fingers 1608 against the trigger lever 1106 and applies an actuating force represented by arrow 1610 to move the trigger lever 1106 from the neutral position to the actuated position, the piston component 1104 is driven toward the rear of the assembly 1100, thereby decreasing the volume within the piston chamber 1606 (see FIG. 11A). The decrease in volume causes fluid flow represented by arrow 1612 to exit the piston chamber 1606 and enter vertical portion 1602 of the fluid outlet passage. Once the fluid has exited the piston chamber 1606, a first portion of the fluid flow represented by arrow 1614 travels upwardly in the vertical portion 1602 and toward the front of the assembly 1100 through horizontal portion 1604 of the fluid outlet passage. Pressure from the fluid flow 1614 against the nozzle valve 1112 located proximate the water jacket 1114 and the nozzle component 1116 forces the plug portion 1152 to travel toward the front of the assembly 1110. The travel of the plug portion 1152 causes the members 1156 to flex or bulge outwardly, moving the conical seat portion 1154 away from its seated position against the engine 1102, permitting fluid to flow as indicated by arrow 1614 around the flexible members 1156 and into the water jacket 1114. If the nozzle component 1116 has been rotated to an opened position, the fluid flow 1614 exits the trigger sprayer assembly 1100 through the water jacket 1114 and the nozzle component 1116.

The fluid flow represented by the arrow 1612 exiting the piston chamber 1606 into the vertical portion 1602 of the flow passage also provides pressure pushing toward the input housing 1108 and the ball member 1110. The pressure of this fluid acts vertically downwards upon the ball member 1110 to maintain the seated position of the ball member 1110 against the input housing 1108, thus maintaining the pressure in the flow passage.

As shown in FIG. 11C, when a user removes their fingers 1608 from the trigger lever 1106, springs move the trigger lever 1106 from the actuated position to the neutral position in the direction represented by the arrow 1618. The coupling of the trigger lever 1106 and the piston component 1104 pulls the piston component 1104 outwardly toward the front of the assembly 1100, thereby increasing the volume of the piston chamber 1606 and creating a vacuum that draws fluid into the piston chamber 1606 as indicated by the arrow 1620. A first portion of the fluid flowing in the direction of arrow 1622 flows through the dip tube 1600 and forces the ball member 1110 to travel upwardly such that the ball member 1110 is lifted off its seat in the input housing 1108, thus permitting fluid to flow through the input housing 1108 and past the ball member 1110. In the absence of the motive force provided by the fluid exiting the piston chamber 1606, the second portion of the fluid positioned above the piston chamber 1606 and represented by arrow 1624 does not exert sufficient pressure against the plug portion 1152 and the nozzle valve 1112 is closed. Accordingly, FIGS. 11B and 11C depict a full stroke of the trigger lever 1106 and a full cycle in the process of discharging and refilling the piston chamber 1606.

The different systems and methods described herein may be used alone or in combination with other systems and devices. Various equivalents, alternatives and modifications are possible within the scope of the appended claims.

What is claimed is:

1. A trigger sprayer assembly for dispensing a fluid, comprising:
an engine comprising a piston chamber and a fluid passage that is fluidly coupled to the piston chamber, the fluid passage extending from an inlet portion to an outlet portion;
a piston comprising a plunger that is disposed within the piston chamber;
a trigger lever coupled to the engine and the piston, the trigger lever configured to pivot between a neutral position and an actuated position;
an input valve configured to control unidirectional fluid flow through the inlet portion of the fluid passage, the input valve comprising a cylindrical body terminating in a flap portion; and
an output valve configured to control unidirectional fluid flow through the outlet portion of the fluid passage;
wherein pivotal movement of the trigger lever from the neutral position to the actuated position pushes the plunger into the piston chamber to drive fluid out of the piston chamber and through the output valve; and
wherein pivotal movement of the trigger lever from the actuated position to the neutral position pulls the plunger out of the piston chamber such that the flap portion of the input valve pivots from a closed position to an opened position and fluid flows through the input valve and into the piston chamber.

2. The trigger sprayer assembly of claim 1, further comprising a nozzle coupled to the engine, wherein rotating the nozzle relative to the engine is configured to modify a spray pattern of fluid exiting the output valve.

3. The trigger sprayer assembly of claim 2, wherein the output valve is located at least partially within the nozzle.

4. The trigger sprayer assembly of claim 1, further comprising a dip tube extending from a first end to a second end, wherein the first end is coupled to the input valve and the second end is positioned within a fluid container.

5. The trigger sprayer assembly of claim 4, wherein the input valve further comprises an annular groove configured to receive the first end of the dip tube.

6. The trigger sprayer assembly of claim 1, wherein the output valve comprises a cylindrical body terminating in a conical slit portion, wherein the conical slit portion is configured to deform to permit a flow of fluid through the output valve.

7. The trigger sprayer assembly of claim 1, wherein the output valve comprises:
a plug portion;
a conical seat portion extending from the plug portion; and
a plurality of flexible members radially distributed about and extending from an outer periphery of the conical seat portion; the plurality of flexible members terminating in a ring member;
wherein the flexible members are configured to deform to permit a flow of fluid through the output valve.

8. The trigger sprayer assembly of claim 1, wherein the input valve is configured to be in the closed position when the output valve is in an opened position, and wherein the input valve is configured to be in the opened position when the output valve is in a closed position.

9. The trigger sprayer assembly of claim 1, wherein the input valve and the output valve are fabricated from a thermoplastic elastomer.

10. A trigger sprayer assembly for dispensing a fluid, comprising:
an engine comprising a piston chamber and a fluid passage that is fluidly coupled to the piston chamber, the fluid passage extending from an inlet portion to an outlet portion;
a piston comprising a plunger that is disposed within the piston chamber;
a trigger lever coupled to the engine and the piston, the trigger lever configured to pivot between a neutral position and an actuated position;
an input valve configured to control unidirectional fluid flow through the inlet portion of the fluid passage; and
an output valve configured to control unidirectional fluid flow through the outlet portion of the fluid passage, wherein the output valve comprises:
a plug portion;
a conical seat portion extending from the plug portion; and
a plurality of flexible members radially distributed about and extending from an outer periphery of the conical seat portion; the plurality of flexible members terminating in a ring member;
wherein pivotal movement of the trigger lever from the neutral position to the actuated position pushes the plunger into the piston chamber to drive fluid out of the piston chamber such that the flexible members deform from a closed position to an opened position to permit a flow of fluid through the output valve; and
wherein pivotal movement of the trigger lever from the actuated position to the neutral position pulls the plunger out of the piston chamber such that the input valve permits a flow of fluid through the input valve and into the piston chamber.

11. The trigger sprayer assembly of claim 10, further comprising a nozzle coupled to the engine, wherein rotating the nozzle relative to the engine is configured to modify a spray pattern of fluid exiting the output valve.

12. The trigger sprayer assembly of claim 11, wherein the output valve is located at least partially within the nozzle.

13. The trigger sprayer assembly of claim 10, wherein the input valve is configured to be in a closed position when the output valve is in the opened position, and wherein the input valve is configured to be in an opened position when the output valve is in the closed position.

14. The trigger sprayer assembly of claim 13, wherein the input valve comprises a cylindrical body terminating in a flap portion, the flap portion configured to rotate upwardly when the input valve is in the opened position.

15. The trigger sprayer assembly of claim 14, further comprising a dip tube extending from a first end to a second end, wherein the first end is coupled to the input valve and the second end is positioned within a fluid container.

16. The trigger sprayer assembly of claim 15, wherein the input valve further comprises an annular groove configured to receive the first end of the dip tube.

17. The trigger sprayer assembly of claim 13, wherein the input valve comprises a ball member, the ball member configured to travel vertically upwards from a valve seat when the input valve is in the opened position.

18. The trigger sprayer assembly of claim 15, wherein the ball member is fabricated from glass or metal.

19. An unidirectional valve for a trigger sprayer assembly, the unidirectional valve comprising:
a base cylindrical body; and
an upper cylindrical body extending from the base cylindrical body and terminating in a flap portion, the flap portion configured to pivot upwardly from a closed position to an opened position to permit a flow of fluid through the unidirectional valve.

20. The unidirectional valve of claim 19, wherein the base cylindrical body comprises an annular groove configured to receive a first end of a dip tube, wherein a second end of the dip tube is located in a fluid container.

21. The unidirectional valve of claim 20 wherein:
the unidirectional valve is made of an elastomeric material and is seated within a tubular valve seat on an input housing;
said input housing comprises a cylindrical base adapted to be attached between a neck closure on a trigger sprayer assembly and the fluid container, the tubular valve seat which extends upward from the cylindrical base at a location offset from a center of the cylindrical base, and one or more vent holes passing through the cylindrical base on a side of the cylindrical base opposite the tubular valve seat; and
further wherein the upper cylindrical body of the unidirectional elastomeric valve is press fit into the tubular valve seat on the input housing such that the base cylindrical body resides underneath the input housing.
